(19) United States
(12) Patent Application Publication
(10) Pub. No.: US 2018/0240466 A1
(43) Pub. Date: Aug. 23, 2018

(54) Speech Decoder and Language Interpreter With Asynchronous Pre-Processing

(71) Applicant: Intel Corporation, Santa Clara, CA (US)

(72) Inventors: Joachim Hofer, Munich (DE); Munir Georges, Kehl (DE)

(21) Appl. No.: 15/436,171

(22) Filed: Feb. 17, 2017

(51) Int. Cl. G10L 19/00; G10L 15/02; G10L 15/01

(52) U.S. Cl. CPC G10L 19/0018; G10L 15/02; G10L 15/04; G10L 2015/025; G10L 15/01

(57) ABSTRACT

An embodiment of a language interpreter apparatus may include a language analyzer to analyze an intermediate recognition result of an electronic speech signal, and a memory to store a language interpretation result of the analysis of the intermediate recognition result, wherein the language analyzer is further to receive a final recognition result of the electronic speech signal, compare the final recognition result to the intermediate recognition result, and retrieve the language interpretation result of the analysis corresponding to the intermediate recognition result if the final recognition result matches the intermediate recognition result. An embodiment of a speech decoder apparatus may include a speech analyzer to analyze an electronic speech signal to determine an intermediate recognition result of the electronic speech signal, and a language interpreter interface communicatively coupled to the speech analyzer to provide the intermediate recognition result to a language interpreter for language interpretation.

### TECHNICAL FIELD

Embodiments generally relate to speech recognition. More particularly, embodiments relate to a speech decoder and language interpreter with asynchronous pre-processing.

### BACKGROUND

A speech recognition system may include various modules, including a decoder module, end of speech detection module, and/or a natural language understanding (NLU) module. In some spoken dialog systems, an electronic speech signal is decoded until the end of speech is detected. The speech recognition result is then processed by the NLU. End of speech detection may be accomplished by checking whether there was a fixed amount of silence after a word or phrase in the electronic speech signal.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a speech recognition system according to an embodiment;

FIG. 2 is a block diagram of an example of a language interpreter apparatus according to an embodiment;

FIGS. 3A to 3C are flowcharts of an example of a method of interpreting language according to an embodiment;

FIG. 4 is a block diagram of an example of a speech decoder apparatus according to an embodiment;

FIGS. 5A to 5C are flowcharts of an example of a method of decoding speech according to an embodiment;

FIG. 6 is a block diagram of another example of a speech recognition system according to an embodiment;

FIG. 7 is a flowchart of an example of a method of understanding natural language according to an embodiment;

FIG. 8 is a flowchart of another example of a method of understanding natural language according to an embodiment;

FIG. 9 is a flowchart of another example of a method of decoding speech according to an embodiment; and

FIG. 10 is a flowchart of another example of a method of decoding speech according to an embodiment.

### DESCRIPTION OF EMBODIMENTS

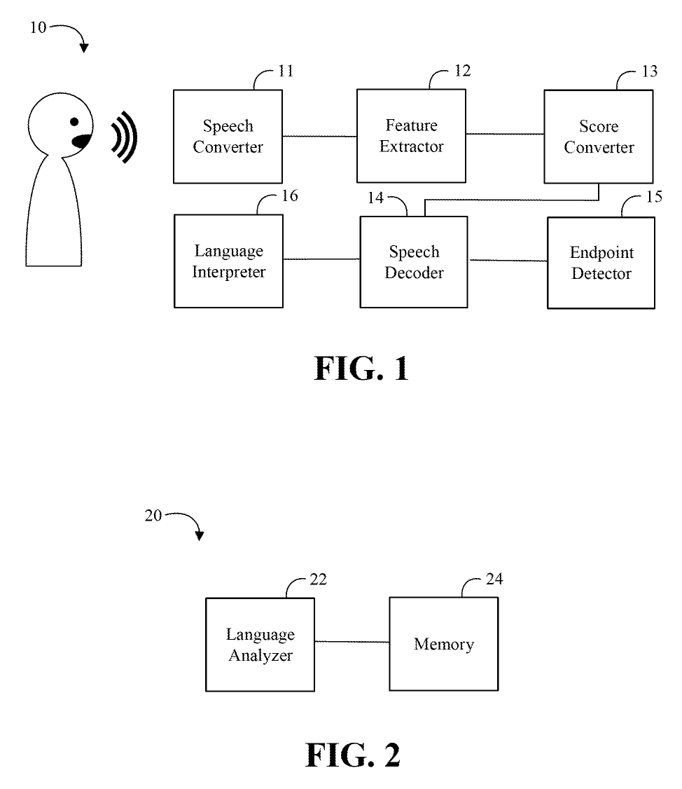

Turning now to FIG. 1, an embodiment of a speech recognition system 10 may include a speech converter 11 to convert speech from a user into an electronic signal, a feature extractor 12 (e.g. an acoustic feature extractor) communicatively coupled to the speech converter 11 to extract speech features from the electronic signal, a score converter 13 communicatively coupled to the feature extractor 12 to convert the speech features into scores of phonetic units, a speech decoder 14 (e.g., a weighted finite state transducer (WFST) based decoder) communicatively coupled to the score converter 13 to decode a phrase spoken by the user based on the phonetic scores, an endpoint detector 15 communicatively coupled to the speech decoder 14 to determine if the decoded phrase corresponds to a complete request, and a language interpreter 16 communicatively coupled to the speech decoder 14 to interpret the request from the user. For example, the speech decoder 14 may be further configured to determine an intermediate recognition result for the decoded phrase and provide the intermediate recognition result to the language interpreter 16. The language interpreter 16 may be further configured to asynchronously interpret the intermediate recognition result from the speech decoder 14 (e.g. while the decoder continues to decode the phrase).

In some embodiments, the speech decoder 14 may include a speech detector which may be a part of a WFST decoder that bases speech/non-speech classification on the WFST state that the best active token is currently in. In different embodiments, the speech detector may be an individual classifier, for example, operating on the acoustic signal or the features from the feature extractor 12. It is also possible to use other features. For example, some synchronous video information that captures the mouth movement to detect speech/non-speech sections or similar information from a noise cancelation algorithm.

In some embodiments of the system 10, the language interpreter 16 may be configured to store an interpretation result based on the intermediate recognition result, receive an indication from the speech decoder that the request is complete, compare the complete request to the intermediate recognition result, and retrieve the stored interpretation result if the complete request matches the intermediate recognition result. Advantageously, because the language interpreter 16 pre-processed the intermediate recognition result, the interpretation result has already been prepared and may be provided from the language interpreter with little or no additional latency. The language interpreter 16 may also be configured to determine decode information based on the interpretation of the intermediate recognition result, and the speech decoder 14 may be further configured to decode the electronic speech signal based on the decode information from the language interpreter 16. For example, the language interpreter 16 may determine that the intermediate recognition result corresponds to a complete request and provide that determination to the endpoint detector 15. The endpoint detector 15 may then stop processing the phrase and indicate to the speech decoder 14 that the request is complete. The language interpreter 16 may also suggest a new hypothesis or recognition result to the decoder 14 and/or endpoint detector.

Non-limiting examples of devices which may utilize the speech recognition system 10 include a server, a computer, a smart device, a gaming console, a wearable device, an internet-of-things (IoT) device, a kiosk, a robot, an automated voice response system, and any human machine interface device which includes voice input as part of its user interaction experience. Embodiments of each of the above speech converter 11, feature extractor 12, score converter 13, speech decoder 14, endpoint detector 15, language interpreter 16, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or in fixed-functionality logic hardware using circuit technology such as, for example, application specific integrated circuit (ASIC), complementary metal oxide semiconductor (CMOS) or transistor-transistor logic (TTL) technology, or any combination thereof Alternatively, or additionally, these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object oriented programming language such as JAVA, Python, SMALLTALK, C++ or the like and conventional procedural programming languages, such as the “C” programming language or similar programming languages.

Turning now to FIG. 2, an embodiment of a language interpreter apparatus 20, may include a language analyzer 22 to analyze an intermediate recognition result of an electronic speech signal, and a memory 24 to store a language interpretation result of the analysis of the intermediate recognition result. For example, the language analyzer 22 may be further configured to receive a final recognition result of the electronic speech signal, compare the final recognition result to the intermediate recognition result, and retrieve the language interpretation result of the analysis corresponding to the intermediate recognition result if the final recognition result matches the intermediate recognition result. In some embodiments, the language analyzer 22 may also provide decode information based on the results of the analysis of the intermediate recognition result (e.g. to a speech decoder). For example, the language analyzer 22 may provide speech endpoint information based on the results of the analysis of the intermediate recognition result (e.g. to an endpoint detector).

In some embodiments, the language analyzer 22 may be configured to work with multiple intermediate results and multiple final results (e.g. from an n-best hypothesis decoder). For example, the language analyzer 22 may be further configured to store one or more language interpretation results of analysis corresponding to one or more intermediate recognition results of the electronic speech signal, receive two or more final recognition results of the electronic speech signal, compare each of the final recognition results to the intermediate recognition results, and retrieve each language interpretation result of the analysis which corresponds to one of the intermediate recognition results matching one of the final recognition results.

Embodiments of each of the above language analyzer 22, memory 24, and other components of the language interpreter apparatus 20 may be implemented in hardware, software, or any combination thereof. For example, hardware implementations may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, Python, SMALLTALK, C++ or the like and conventional procedural programming languages, such as the “C” programming language or similar programming languages.

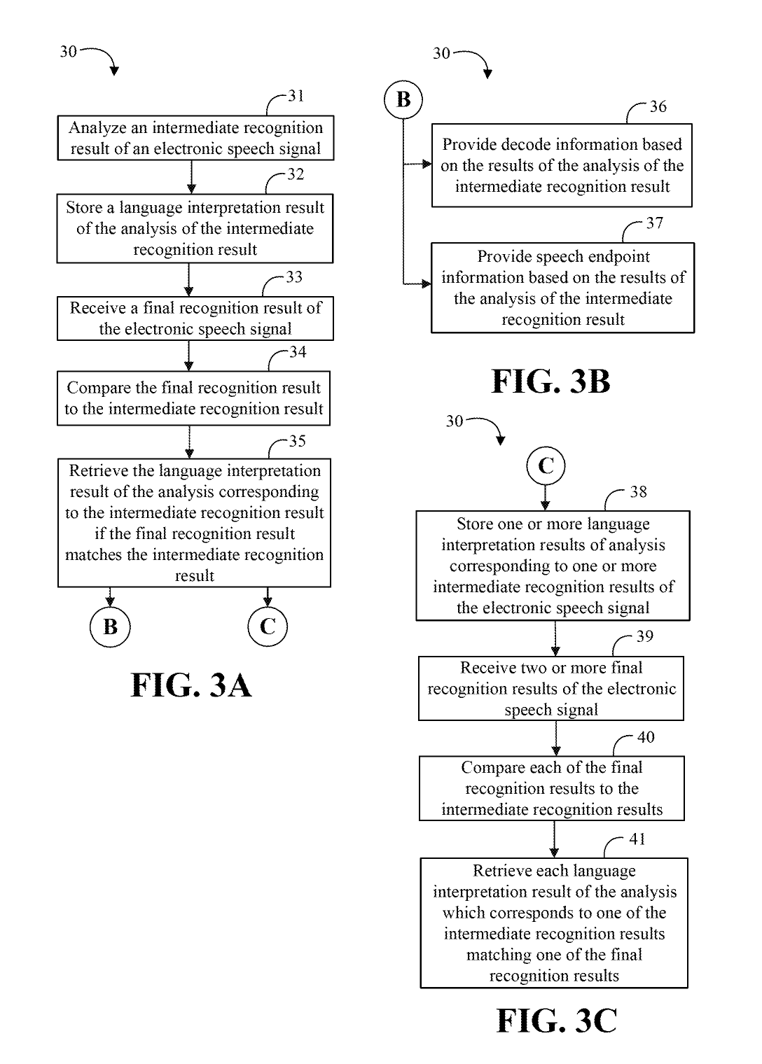

Turning now to FIGS. 3A to 3C, an embodiments of a method 30 of interpreting language may include analyzing an intermediate recognition result of an electronic speech signal at block 31, storing a language interpretation result of the analysis of the intermediate recognition result at block 32, receiving a final recognition result of the electronic speech signal at block 33, comparing the final recognition result to the intermediate recognition result at block 34, and retrieving the language interpretation result of the analysis corresponding to the intermediate recognition result if the final recognition result matches the intermediate recognition result at block 35. Some embodiments of the method 30 may further include providing decode information based on the results of the analysis of the intermediate recognition result at block 36. For example, the method 30 may include providing speech endpoint information based on the results of the analysis of the intermediate recognition result at block 37.

In some embodiments, the method may further include storing one or more language interpretation results of analysis corresponding to one or more intermediate recognition results of the electronic speech signal at block 38, receiving two or more final recognition results of the electronic speech signal at block 39, comparing each of the final recognition results to the intermediate recognition results at block 40, and retrieving each language interpretation result of the analysis which corresponds to one of the intermediate recognition results matching one of the final recognition results at block 41.

Embodiments of the method 30 may be implemented in a speech recognition system or language interpreter apparatus such as, for example, those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, Python, SMALLTALK, C++ or the like and conventional procedural programming languages, such as the “C” programming language or similar programming languages. For example, the method 30 may be implemented on a computer readable medium as described in connection with Examples 22 to 25 below.

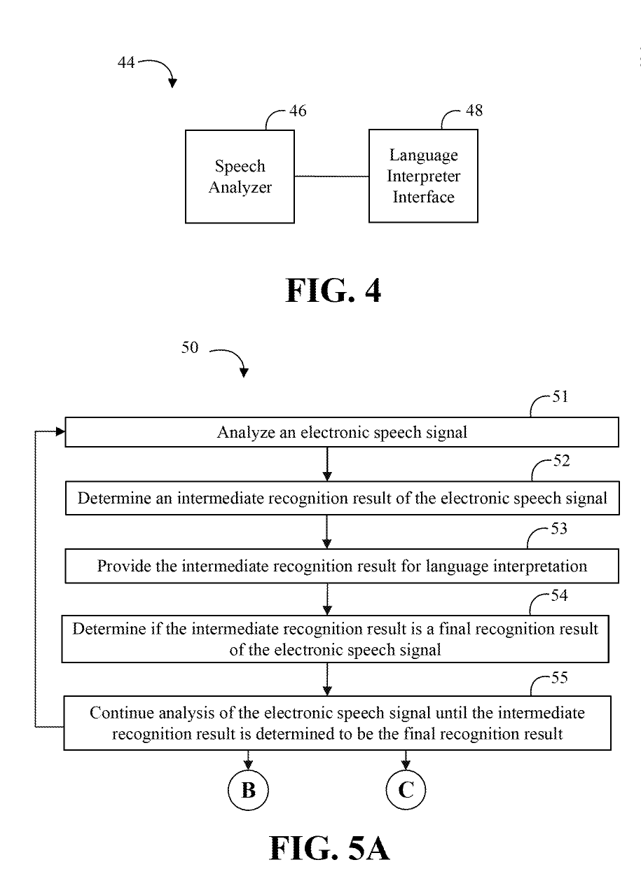

Turning now to FIG. 4, an embodiment of a speech decoder apparatus 44, may include a speech analyzer 46 to analyze an electronic speech signal to determine an intermediate recognition result of the electronic speech signal, and a language interpreter interface 48 communicatively coupled to the speech analyzer 46 to provide the intermediate recognition result to a language interpreter for language interpretation. For example, the speech analyzer 46 may be further configured to determine if the intermediate recognition result is a final recognition result of the electronic speech signal, and continue analysis of the electronic speech signal until the intermediate recognition result is determined to be the final recognition result. In some embodiments, the speech analyzer 46 may be further configured to determine a new intermediate recognition result, and the language interpreter interface 48 may provide the new intermediate recognition result to the language interpreter for language interpretation.

In some embodiments of the apparatus 44, the language interpreter interface 48 may be further configured to receive information related to language interpretation of the intermediate result, and the speech analyzer 46 may analyze the electronic speech signal based on the received information. For example, the speech analyzer 46 may determine an endpoint of the electronic speech signal based on the received information. For example, the speech analyzer 46 may determine that the intermediate recognition result is the final recognition result based on the received information.

Embodiments of each of the above speech analyzer 46, language interpreter interface 48, and other components of the speech decoder apparatus 44 may be implemented in hardware, software, or any combination thereof. For example, hardware implementations may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, Python, SMALLTALK, C++ or the like and conventional procedural programming languages, such as the “C” programming language or similar programming languages.

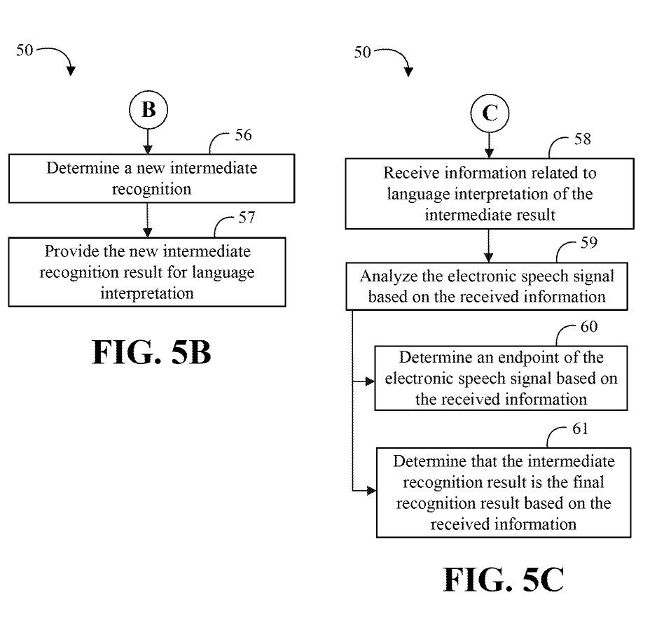

Turning now to FIGS. 5A to 5C, an embodiment of a method 50 of decoding speech may include analyzing an electronic speech signal at block 51, determining an intermediate recognition result of the electronic speech signal at block 52, providing the intermediate recognition result for language interpretation at block 53, determining if the intermediate recognition result is a final recognition result of the electronic speech signal at block 54, and continuing analysis of the electronic speech signal until the intermediate recognition result is determined to be the final recognition result at block 55. For example, some embodiments may include determining a new intermediate recognition result at block 56, and providing the new intermediate recognition result for language interpretation at block 57.

Some embodiments of the method 50 may also include receiving information related to language interpretation of the intermediate result at block 58, and analyzing the electronic speech signal based on the received information at block 59. For example, the method 50 may include determining an endpoint of the electronic speech signal based on the received information at block 60 and/or determining that the intermediate recognition result is the final recognition result based on the received information at block 61.

Embodiments of the method 50 may be implemented in a speech recognition system or speech decoder apparatus such as, for example, those described herein. More particularly, hardware implementations of the method 50 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 50 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, Python, SMALLTALK, C++ or the like and conventional procedural programming languages, such as the “C” programming language or similar programming languages. For example, the method 50 may be implemented on a computer readable medium as described in connection with Examples 30 to 33 below.

Machines with a spoken human machine interface (e.g. wearable devices, home automation, personal assistants) may have to determine whether a user completed his/her request or whether the user is still speaking. If the machine waits too long after the user input, the latency has a negative impact on the user experience. If the machine reacts too fast, it may interrupt a user or may misunderstand a user by evaluating incomplete requests. Both cases may result in a bad user experience.

A spoken dialog system may comprise multiple modules including, for example, speech decoding, end of speech detection, and NLU. Each module may introduce a latency that may adversely affect the user experience. Advantageously, some embodiments may provide latency reduction for natural language understanding of speech. For example, some embodiments may utilize speculative execution in an NLU to reduce latency without compromising accuracy.

For example, some embodiments may reduce or minimize the overall latency by interleaving automatic speech recognition (ASR) and NLU processing using streamlined and speculative computation. The ASR may include speech decoding and endpoint detection. An asynchronous or parallel processing schedule and a semantic aware end of speech detection may be utilized to continuously or periodically evaluate each speech recognition hypothesis by the NLU. The result of the evaluation may be held by the NLU or discarded depending on the result of the end of speech detection of the current hypotheses. Another advantage of interleaving ASR and NLU may include having the end of speech detection make use of intermediate NLU results that may further increase the recognition and/or endpoint accuracy.

In some spoken dialog systems, the electronic speech signal is decoded until the end of speech is detected. The speech recognition result is then processed by the NLU. The end of speech detection is non-semantic-aware. End of speech detection is accomplished by checking whether there was a fixed amount of silence or whether the best recognition hypothesis has not changed for a fixed amount of time. This processing schedule may increase latency and cause compute spikes. Attempts to reduce latency in the individual modules may also reduce accuracy.

Advantageously, some embodiments may provide a processing schedule where the time until end of speech is detected may be used to speculatively compute the NLU. This may allow accuracy improved or optimized speech decoding (e.g. use of less aggressive pruning of the lattice re-scoring or use of a bigger search space). The NLU computation may be streamlined and speculative (e.g. the computed NLU may or may not correspond to the final recognition result). This approach may reduce compute spikes and the NLU results may be available without lag (e.g. when the speculatively computed NLU matches the final recognition result). Moreover, the end of speech detection may be enhanced by using semantic information from intermediate NLU results (e.g. reduced or minimal risk of processing a truncated electronic speech signal). Some embodiments may simplify the calibration/optimization process for different hardware and speech use-cases. Advantageously, the reduced latency without comprising recognition accuracy may significantly improves the user experience.

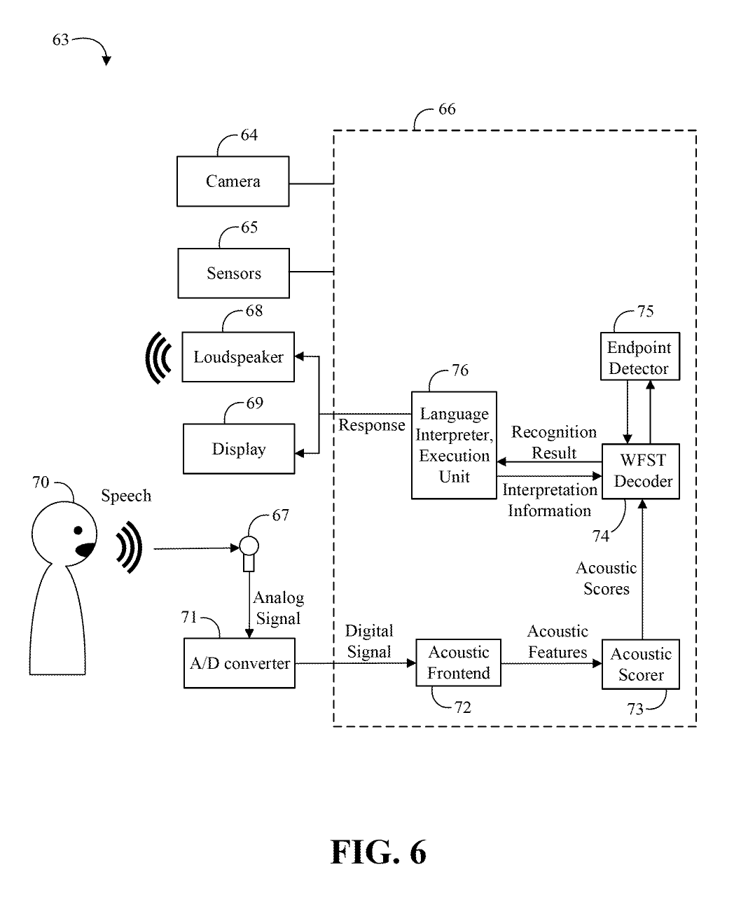

Turning now to FIG. 6, a speech enabled human machine interface (HMI) system 63 may include a camera 64 and other sensors 65 coupled to a processor 66 to capture and interpret an environmental or situational context. For example, some embodiments of the speech enabled HMI system 63 may incorporate video or other sensor information to determine if the user is still talking to the system 63 (e.g. by evaluating a video signal and/or analyzing the mouth movement). The system 63 may also record audio with a microphone 67, process the acoustic data with the processor 66, and then output speech (e.g. via loudspeaker 68) or visual information (e.g. via display 69) to the user or execute commands based on the user's request. The speech from a user 70 may be captured by the microphone 67 and converted into digital signals by an analog-to-digital (A/D) converter 71 before being processed by the processor 66. The processor 66 may include an acoustic frontend 72 to extract acoustic features, which may then be converted into acoustic scores of phonetic units by an acoustic scorer 73. The processor 66 may extract acoustic features including, for example, mel frequency cepstral coefficients (MFCCs), which may be converted into acoustic scores of phonetic units using, for example, a deep neural network (DNN). Those acoustic scores may then be provided to a decoder 74 (e.g. based on WFST) to determine the phrase spoken by the user 70.

An endpoint detector 75 may be coupled to the decoder 74 to determine whether the user has finished their request. The recognition result from the decoder 74 may be provided to a language interpreter/execution unit 76 to process the user request and make an appropriate response (e.g. via the loudspeaker 68 and/or the display 69). Advantageously, the endpoint detector 75 may be configured to improve the response time of the system 63 and also to reduce the number of interruptions by utilizing an adaptive and/or context aware time threshold for endpoint detection. In a conventional system, the recognition result is handed to the NLU only after an endpoint is detected. Advantageously, some embodiments of the decoder 74 may pass the current best recognition hypothesis to the language interpreter 76 before the endpoint is detected. For example, an intermediate hypothesis may be transferred continuously, regularly, or periodically from the decoder 74 to the language interpreter 76. An intermediate hypothesis may be transferred, for example, either in regular intervals (e.g. every 500 ms) or whenever the best recognition result changes.

For example, the language interpreter/execution unit 76 may provide an ASR module for the HMI to turn the speech into text form. The semantic content of the text may then be extracted to execute a command or to form an appropriate response. For example, the language interpreter may extract the user intent from the recognition result. In some embodiments, the language interpreter 76 may interpret an intermediate result and store an associated result (e.g. in some form of cache, memory, or register) without processing it further or providing a response. For example, the memory/cache may only contain one entry which stores the latest computation. Alternatively, the memory/cache may contain multiple entries to store multiple computations for multiple intermediate results.

If the decoder 74 sends a new recognition hypothesis, the language interpreter 76 may check whether it has the intent for that result cached, or extract the user intent as needed. If a new intent is extracted, the extracted intent may then be cached (e.g. potentially overwriting a previously cached intent depending on how many results the system can store). When the endpoint detector 75 detects an end of speech, the decoder 74 sends its final result to the language interpreter 76 and signals that an endpoint was detected. The language interpreter 76 may then check whether it has the intent of that result stored based on a comparison of the final result to any stored results. If so, the language interpreter 76 may execute the action corresponding to the stored intent. If the recognition result is not stored, the language interpreter 76 may first extract the intent of the final result and then execute it.

In some embodiments, the ASR module may include a WFST decoder and endpoint detector that provide semantic aware endpoint detection in which intermediate results are developed. The ASR module may pass the intermediate results to the NLU module, which can begin processing them while ASR continues. If the intermediate result is the same as the final from the ASR, the NLU saves times by using the result of the intermediate result processing along a parallel or asynchronous execution path. For example, the system may have multiple processors that support an asynchronous or parallel execution path. In some embodiments, the modules may run on separate machines or servers. For example, the ASR may run on a server (e.g. the cloud) while the NLU runs on a client. An additional advantage may be provided with bi-directional communication between the ASR and the NLU modules in that the NLU can give information to the ASR (e.g. the NLU determines that the sentence is complete after examining the intermediate results). The NLU may get the intermediate results and give the ASR information back which the ASR can use to improve or optimize the endpoint detection and/or decoding.

In some embodiments, the ASR may transmit a new intermediate result whenever the current hypothesis changes. Some embodiments may alternatively or additionally utilize a timer to control when an intermediate result is sent from the ASR to the NLU. For example, the ASR may transmit an intermediate result if both the hypothesis changed and at least 500 ms have passed. Using the timer may avoid sending too many intermediate results to the NLU. In some embodiments, the time interval may correspond to an amount of time needed by the NLU to perform its interpretation.

In some embodiments, the ASR may produce a single best hypothesis or n-best hypotheses. For example, the ASR can produce more than one hypothesis. If the user doesn't speak clearly, for example, the ASR may have trouble distinguishing “I can” from “I can't”. The ASR may deliver both results to the NLU and the NLU can process both to make a further determination. The ASR may return N possible answers, where N is greater than or equal to one. Intermediate results may generally be provided to the NLU one at a time, but the final result may include multiple possibilities. In any of the n-best results correspond to the cached result(s), the NLU can advantageously skip the work for those result.

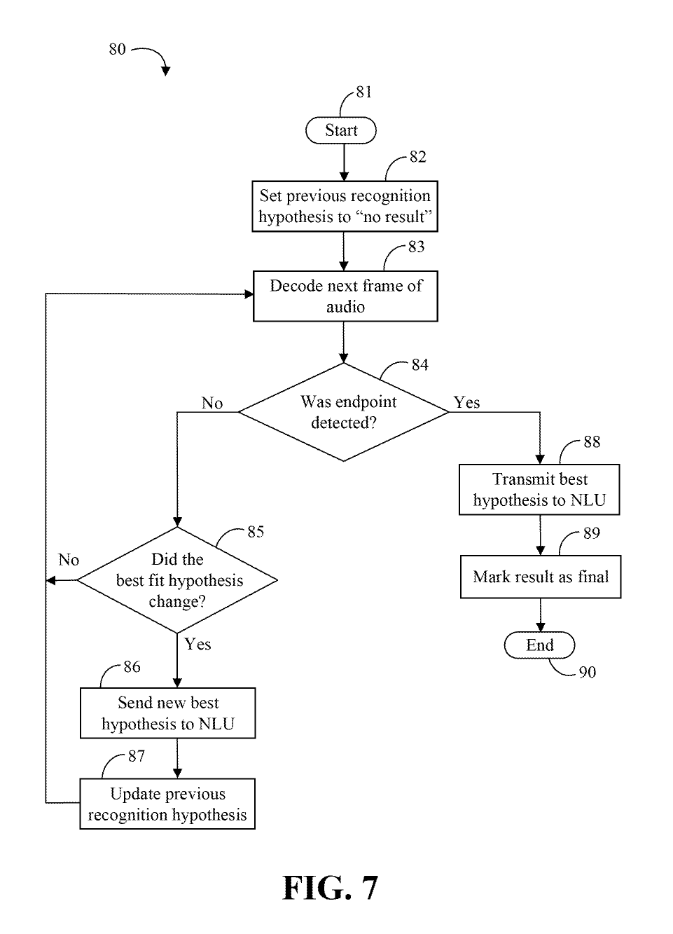

Turning now to FIG. 7, an embodiment of a method 80 of decoding speech may start at block 81. A previous recognition hypothesis may be set to “no result” at block 82. A next frame of audio may then be decoded at block 83. If the ASR did not detect an endpoint at block 84, the ASR may determine if the best fit hypothesis changed at block 85. If the hypothesis did not change at block 85, the method 80 may continue to decode the next frame of audio at block 83. If the hypothesis was changed at block 85, the new best hypothesis may be sent to the NLU at block 86, the previous recognition hypothesis may be updated as the new best hypothesis at block 87, and the method 80 may continue to decode the next frame of audio at block 83. If the ASR detected an endpoint at block 84, the ASR may transmit the best hypothesis the NLU at block 88, mark the result as final at block 89, and the decoding may end at block 90.

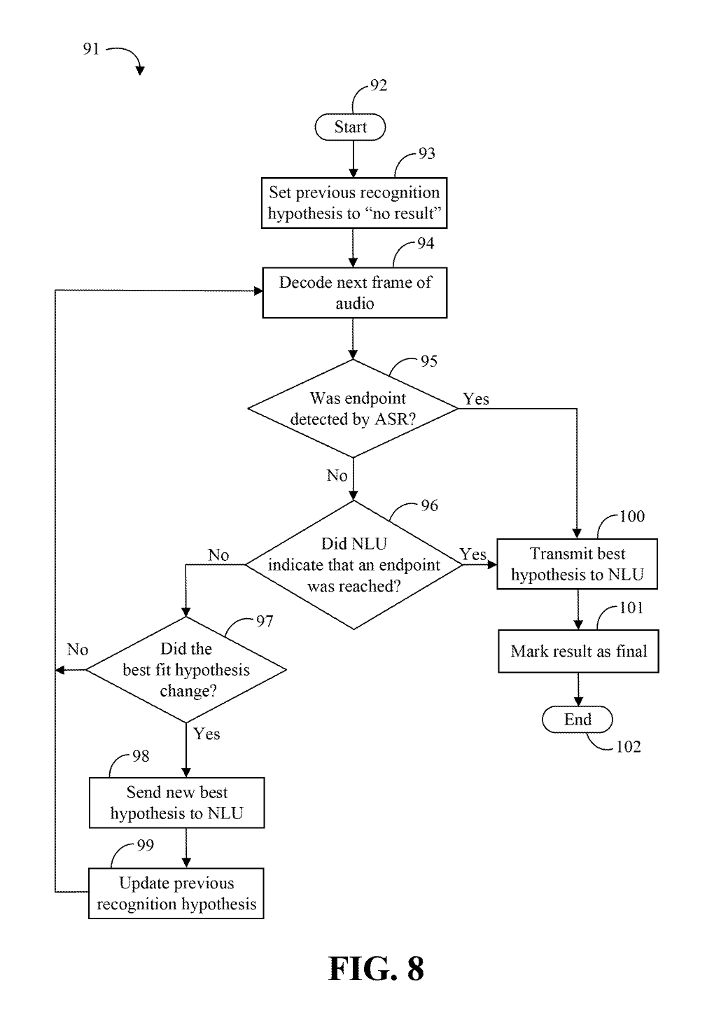

Turning now to FIG. 8, another embodiment of a method 91 of decoding speech may start at block 92. A previous recognition hypothesis may be set to “no result” at block 93. A next frame of audio may then be decoded at block 94. If the ASR did not detect an endpoint at block 95, the ASR may determine if the NLU indicated that an endpoint was reached at block 96. If neither the ASR detected an endpoint (at block 95) nor the NLU indicated that an endpoint was reached (at block 96), the ASR may determine if the best fit hypothesis changed at block 97. If the hypothesis did not change at block 97, the method 91 may continue to decode the next frame of audio at block 94. If the hypothesis was changed at block 97, the new best hypothesis may be sent to the NLU at block 98, the previous recognition hypothesis may be updated as the new best hypothesis at block 99, and the method 91 may continue to decode the next frame of audio at block 94. If the either the ASR detected an endpoint at block 95 or the NLU indicated an endpoint was reached at block 96, the ASR may transmit the best hypothesis the NLU at block 100, mark the result as final at block 101, and the decoding may end at block 102.

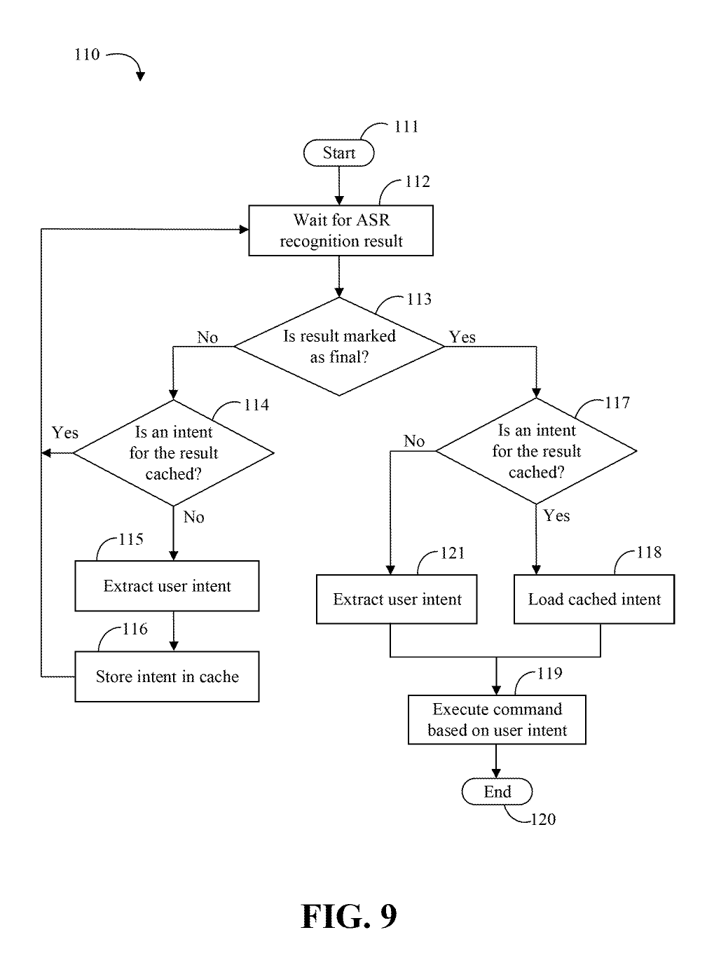

Turning now to FIG. 9, an embodiment of a method 110 of understanding natural language may start at block 111. The NLU may wait for an ASR recognition result at block 112. After the NLU gets the recognition result from the ASR, the NLU may determine if the result is marked as final at block 113. If the result is not marked as final at block 113, the NLU may determine if an intent for the result is cached at block 114. If the intent is cached at block 114, then the method 110 may continue with the NLU waiting for an ASR recognition result at block 112. If the intent for the recognition result is not already cached at block 114, the NLU may compute/extract the user intent at block 115 and store the intent in the cache at block 116, after which the method 110 continues with the NLU waiting for an ASR recognition result at block 112. If the result is marked as final at block 113, the NLU may determine if an intent for the result is cached at block 117. If the intent is cached at block 117, then the NLU may load the cached intent at block 118, execute a command based on the user intent at block 119, and the NLU processing may end at block 120. If the intent for the recognition result is not already cached at block 117, the NLU may compute/extract the user intent at block 121, execute a command based on the user intent at block 119, and the NLU processing may end at block 120.

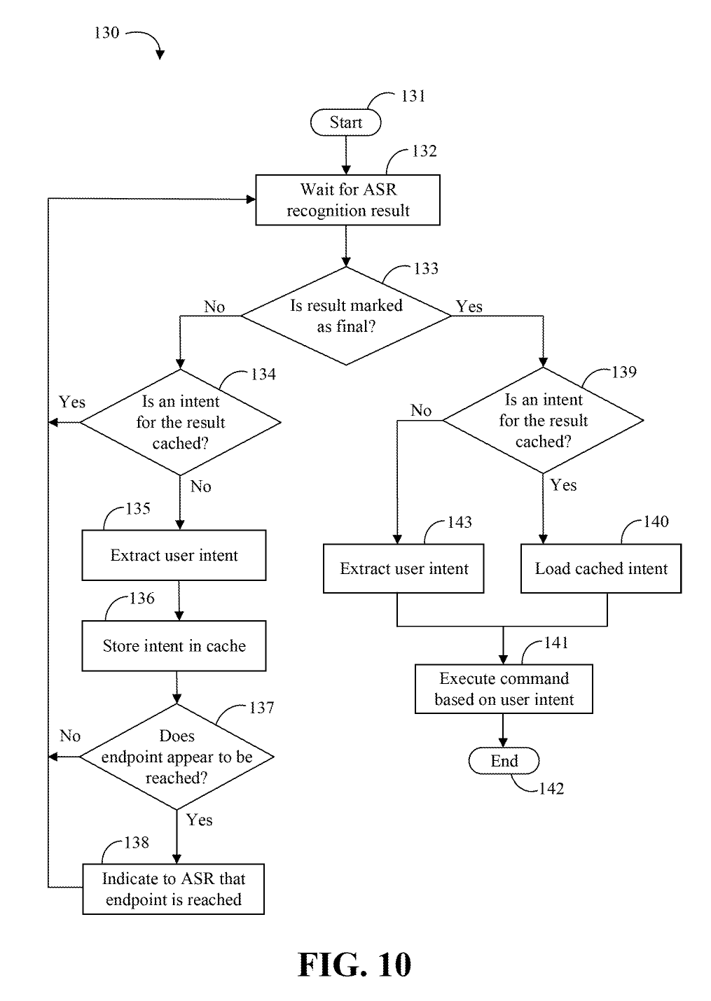

Turning now to FIG. 10, an embodiment of a method 130 of understanding natural language may start at block 131. The NLU may wait for an ASR recognition result at block 132. After the NLU gets the recognition result from the ASR, the NLU may determine if the result is marked as final at block 133. If the result is not marked as final at block 133, the NLU may determine if an intent for the result is cached at block 134. If the intent is cached at block 134, then the method 130 may continue with the NLU waiting for an ASR recognition result at block 132. If the intent for the recognition result is not already cached at block 134, the NLU may compute/extract the user intent at block 135 and store the intent in the cache at block 136. The NLU may then determine if the endpoint appears to be reached at block 137 (e.g. if the intent appears clear based on the context). If the endpoint does not appear to be reached, the method 130 may continue with the NLU waiting for an ASR recognition result at block 132. If the endpoint appears to be reached, the NLU may indicate to the ASR that the endpoint appears to be reached and the method 130 may then continue with the NLU waiting for an ASR recognition result at block 132.

If the result is marked as final at block 133, the NLU may determine if an intent for the result is cached at block 139. If the intent is cached at block 139, then the NLU may load the cached intent at block 140, execute a command based on the user intent at block 141, and the NLU processing may end at block 142. If the intent for the recognition result is not already cached at block 139, the NLU may compute/extract the user intent at block 143, execute a command based on the user intent at block 141, and the NLU processing may end at block 142.

### Additional Notes and Examples

Example 1 may include a speech recognition system, comprising a speech converter to convert speech from a user into an electronic signal, a feature extractor communicatively coupled to the speech converter to extract speech features from the electronic signal, a score converter communicatively coupled to the feature extractor to convert the speech features into scores of phonetic units, a speech decoder communicatively coupled to the score converter to decode a phrase spoken by the user based on the scores, an endpoint detector communicatively coupled to the speech decoder to determine if the decoded phrase corresponds to a complete request, and a language interpreter communicatively coupled to the speech decoder to interpret the complete request from the user, wherein the speech decoder is further to determine an intermediate recognition result for the decoded phrase and provide the intermediate recognition result to the language interpreter, and the language interpreter is further to asynchronously interpret the intermediate recognition result from the speech decoder.

Example 2 may include the system of Example 1, wherein the language interpreter is further to determine decode information based on the interpretation of the intermediate recognition result, and wherein the speech decoder is further to decode the electronic speech signal based on the decode information from the language interpreter.

Example 3 may include the system of any of Examples 1 to 2, wherein the language interpreter is further to store an interpretation result based on the intermediate recognition result, receive an indication from the speech decoder that the request is complete, compare the complete request to the intermediate recognition result, and retrieve the stored interpretation result if the complete request matches the intermediate recognition result.

Example 4 may include a language interpreter apparatus, comprising a language analyzer to analyze an intermediate recognition result of an electronic speech signal, and a memory to store a language interpretation result of the analysis of the intermediate recognition result, wherein the language analyzer is further to receive a final recognition result of the electronic speech signal, compare the final recognition result to the intermediate recognition result, and retrieve the language interpretation result of the analysis corresponding to the intermediate recognition result if the final recognition result matches the intermediate recognition result.

Example 5 may include the apparatus of Example 4, wherein the language analyzer is further to provide decode information based on the results of the analysis of the intermediate recognition result.

Example 6 may include the apparatus of Example 4, wherein the language analyzer is further to provide speech endpoint information based on the results of the analysis of the intermediate recognition result.

Example 7 may include the apparatus of any of Examples 4 to 6, wherein the language analyzer is further to store one or more language interpretation results of analysis corresponding to one or more intermediate recognition results of the electronic speech signal, receive two or more final recognition results of the electronic speech signal, compare each of the final recognition results to the intermediate recognition results, and retrieve each language interpretation result of the analysis which corresponds to one of the intermediate recognition results matching one of the final recognition results.

Example 8 may include a method of interpreting language, comprising analyzing an intermediate recognition result of an electronic speech signal, storing a language interpretation result of the analysis of the intermediate recognition result, receiving a final recognition result of the electronic speech signal, comparing the final recognition result to the intermediate recognition result, and retrieving the language interpretation result of the analysis corresponding to the intermediate recognition result if the final recognition result matches the intermediate recognition result.

Example 9 may include the method of Example 8, further comprising providing decode information based on the results of the analysis of the intermediate recognition result.

Example 10 may include the method of Example 8, further comprising providing speech endpoint information based on the results of the analysis of the intermediate recognition result.

Example 11 may include the method of any of Examples 8 to 10, further comprising storing one or more language interpretation results of analysis corresponding to one or more intermediate recognition results of the electronic speech signal, receiving two or more final recognition results of the electronic speech signal, comparing each of the final recognition results to the intermediate recognition results, and retrieving each language interpretation result of the analysis which corresponds to one of the intermediate recognition results matching one of the final recognition results.

Example 12 may include a speech decoder apparatus, comprising a speech analyzer to analyze an electronic speech signal to determine an intermediate recognition result of the electronic speech signal, and a language interpreter interface communicatively coupled to the speech analyzer to provide the intermediate recognition result to a language interpreter for language interpretation, wherein the speech analyzer is further to determine if the intermediate recognition result is a final recognition result of the electronic speech signal, and continue analysis of the electronic speech signal until the intermediate recognition result is determined to be the final recognition result.

Example 13 may include the apparatus of Example 12, wherein the speech analyzer is further to determine a new intermediate recognition result, and wherein the language interpreter interface is further to provide the new intermediate recognition result to the language interpreter for language interpretation.

Example 14 may include the apparatus of any of Examples 12 to 13, wherein the language interpreter interface is further to receive information related to language interpretation of the intermediate result, and wherein the speech analyzer is further to analyze the electronic speech signal based on the received information.

Example 15 may include the apparatus of Example 14, wherein the speech analyzer is further to determine an endpoint of the electronic speech signal based on the received information.

Example 16 may include the apparatus of Example 14, wherein the speech analyzer is further to determine that the intermediate recognition result is the final recognition result based on the received information.

Example 17 may include a method of decoding speech, comprising analyzing an electronic speech signal, determining an intermediate recognition result of the electronic speech signal, providing the intermediate recognition result for language interpretation, determining if the intermediate recognition result is a final recognition result of the electronic speech signal, and continuing analysis of the electronic speech signal until the intermediate recognition result is determined to be the final recognition result.

Example 18 may include the method of Example 17, further comprising determining a new intermediate recognition result, and providing the new intermediate recognition result for language interpretation.

Example 19 may include the method of any of Examples 17 to 18, further comprising receiving information related to language interpretation of the intermediate result, and analyzing the electronic speech signal based on the received information.

Example 20 may include the method of Example 19, further comprising determining an endpoint of the electronic speech signal based on the received information.

Example 21 may include the method of Example 19, further comprising determining that the intermediate recognition result is the final recognition result based on the received information.

Example 22 may include at least one computer readable medium, comprising a set of instructions, which when executed by a computing device, cause the computing device to analyze an intermediate recognition result of an electronic speech signal, store a language interpretation result of the analysis of the intermediate recognition result, receive a final recognition result of the electronic speech signal, compare the final recognition result to the intermediate recognition result, and retrieve the language interpretation result of the analysis corresponding to the intermediate recognition result if the final recognition result matches the intermediate recognition result.

Example 23 may include the at least one computer readable medium of Example 22, comprising a further set of instructions, which when executed by a computing device, cause the computing device to provide decode information based on the results of the analysis of the intermediate recognition result.

Example 24 may include the at least one computer readable medium of Example 22, comprising a further set of instructions, which when executed by a computing device, cause the computing device to provide speech endpoint information based on the results of the analysis of the intermediate recognition result.

Example 25 may include the at least one computer readable medium of any of Examples 22 to 24, comprising a further set of instructions, which when executed by a computing device, cause the computing device to store one or more language interpretation results of analysis corresponding to one or more intermediate recognition results of the electronic speech signal, receive two or more final recognition results of the electronic speech signal, compare each of the final recognition results to the intermediate recognition results, and retrieve each language interpretation result of the analysis which corresponds to one of the intermediate recognition results matching one of the final recognition results.

Example 26 may include a language interpreter apparatus, comprising means for analyzing an intermediate recognition result of an electronic speech signal, means for storing a language interpretation result of the analysis of the intermediate recognition result, means for receiving a final recognition result of the electronic speech signal, means for comparing the final recognition result to the intermediate recognition result, and means for retrieving the language interpretation result of the analysis corresponding to the intermediate recognition result if the final recognition result matches the intermediate recognition result.

Example 27 may include the apparatus of Example 26, further comprising means for providing decode information based on the results of the analysis of the intermediate recognition result.

Example 28 may include the apparatus of Example 26, further comprising means for providing speech endpoint information based on the results of the analysis of the intermediate recognition result.

Example 29 may include the apparatus of any of Examples 26 to 28, further comprising means for storing one or more language interpretation results of analysis corresponding to one or more intermediate recognition results of the electronic speech signal, means for receiving two or more final recognition results of the electronic speech signal, means for comparing each of the final recognition results to the intermediate recognition results, and means for retrieving each language interpretation result of the analysis which corresponds to one of the intermediate recognition results matching one of the final recognition results.

Example 30 may include at least one computer readable medium, comprising a set of instructions, which when executed by a computing device, cause the computing device to analyze an electronic speech signal, determine an intermediate recognition result of the electronic speech signal, provide the intermediate recognition result for language interpretation, determine if the intermediate recognition result is a final recognition result of the electronic speech signal, and continue analysis of the electronic speech signal until the intermediate recognition result is determined to be the final recognition result.

Example 31 may include the at least one computer readable medium of Example 30, comprising a further set of instructions, which when executed by a computing device, cause the computing device to determine a new intermediate recognition result, and provide the new intermediate recognition result for language interpretation.

Example 31 may include the at least one computer readable medium of any of Examples 30 to 31, comprising a further set of instructions, which when executed by a computing device, cause the computing device to receive information related to language interpretation of the intermediate result, and analyze the electronic speech signal based on the received information.

Example 32 may include the at least one computer readable medium of Example 31, comprising a further set of instructions, which when executed by a computing device, cause the computing device to determine an endpoint of the electronic speech signal based on the received information.

Example 33 may include the at least one computer readable medium of Example 31, comprising a further set of instructions, which when executed by a computing device, cause the computing device to determine that the intermediate recognition result is the final recognition result based on the received information.

Example 34 may include a speech decoder apparatus, comprising means for analyzing an electronic speech signal, means for determining an intermediate recognition result of the electronic speech signal, means for providing the intermediate recognition result for language interpretation, means for determining if the intermediate recognition result is a final recognition result of the electronic speech signal, and means for continuing analysis of the electronic speech signal until the intermediate recognition result is determined to be the final recognition result.

Example 35 may include the apparatus of Example 34, further comprising means for determining a new intermediate recognition result, and means for providing the new intermediate recognition result for language interpretation.

Example 36 may include the apparatus of any of Examples 34 to 35, further comprising means for receiving information related to language interpretation of the intermediate result, and means for analyzing the electronic speech signal based on the received information.

Example 37 may include the apparatus of Example 36, further comprising means for determining an endpoint of the electronic speech signal based on the received information.

Example 38 may include the apparatus of Example 36, further comprising means for determining that the intermediate recognition result is the final recognition result based on the received information.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A speech recognition system, comprising:
a speech converter to convert speech from a user into an electronic signal;
a feature extractor communicatively coupled to the speech converter to extract speech features from the electronic signal;
a score converter communicatively coupled to the feature extractor to convert the speech features into scores of phonetic units;
a speech decoder communicatively coupled to the score converter to decode a phrase spoken by the user based on the scores;
an endpoint detector communicatively coupled to the speech decoder to determine if the decoded phrase corresponds to a complete request; and
a language interpreter communicatively coupled to the speech decoder to interpret the complete request from the user, wherein:
the speech decoder is further to determine an intermediate recognition result for the decoded phrase and provide the intermediate recognition result to the language interpreter, and
the language interpreter is further to asynchronously interpret the intermediate recognition result from the speech decoder.

2. The system of claim 1, wherein the language interpreter is further to determine decode information based on the interpretation of the intermediate recognition result, and wherein the speech decoder is further to decode the electronic speech signal based on the decode information from the language interpreter.

3. The system of claim 1, wherein the language interpreter is further to:
store an interpretation result based on the intermediate recognition result;
receive an indication from the speech decoder that the request is complete;
compare the complete request to the intermediate recognition result; and
retrieve the stored interpretation result if the complete request matches the intermediate recognition result.

4. A language interpreter apparatus, comprising:
a language analyzer to analyze an intermediate recognition result of an electronic speech signal; and
a memory to store a language interpretation result of the analysis of the intermediate recognition result, wherein the language analyzer is further to:
receive a final recognition result of the electronic speech signal,
compare the final recognition result to the intermediate recognition result, and
retrieve the language interpretation result of the analysis corresponding to the intermediate recognition result if the final recognition result matches the intermediate recognition result.

5. The apparatus of claim 4, wherein the language analyzer is further to provide decode information based on the results of the analysis of the intermediate recognition result.

6. The apparatus of claim 4, wherein the language analyzer is further to provide speech endpoint information based on the results of the analysis of the intermediate recognition result.

7. The apparatus of claim 4, wherein the language analyzer is further to:
store one or more language interpretation results of analysis corresponding to one or more intermediate recognition results of the electronic speech signal;
receive two or more final recognition results of the electronic speech signal;
compare each of the final recognition results to the intermediate recognition results; and
retrieve each language interpretation result of the analysis which corresponds to one of the intermediate recognition results matching one of the final recognition results.

8. A method of interpreting language, comprising:
analyzing an intermediate recognition result of an electronic speech signal;
storing a language interpretation result of the analysis of the intermediate recognition result;
receiving a final recognition result of the electronic speech signal;
comparing the final recognition result to the intermediate recognition result; and
retrieving the language interpretation result of the analysis corresponding to the intermediate recognition result if the final recognition result matches the intermediate recognition result.

9. The method of claim 8, further comprising:
providing decode information based on the results of the analysis of the intermediate recognition result.

10. The method of claim 8, further comprising:
providing speech endpoint information based on the results of the analysis of the intermediate recognition result.

11. The method of claim 8, further comprising:
storing one or more language interpretation results of analysis corresponding to one or more intermediate recognition results of the electronic speech signal;
receiving two or more final recognition results of the electronic speech signal;
comparing each of the final recognition results to the intermediate recognition results; and
retrieving each language interpretation result of the analysis which corresponds to one of the intermediate recognition results matching one of the final recognition results.

12. A speech decoder apparatus, comprising:
a speech analyzer to analyze an electronic speech signal to determine an intermediate recognition result of the electronic speech signal; and
a language interpreter interface communicatively coupled to the speech analyzer to provide the intermediate recognition result to a language interpreter for language interpretation, wherein the speech analyzer is further to:
determine if the intermediate recognition result is a final recognition result of the electronic speech signal, and
continue analysis of the electronic speech signal until the intermediate recognition result is determined to be the final recognition result.

13. The apparatus of claim 12, wherein the speech analyzer is further to determine a new intermediate recognition result, and wherein the language interpreter interface is further to provide the new intermediate recognition result to the language interpreter for language interpretation.

14. The apparatus of claim 12, wherein the language interpreter interface is further to receive information related to language interpretation of the intermediate result, and wherein the speech analyzer is further to analyze the electronic speech signal based on the received information.

15. The apparatus of claim 14, wherein the speech analyzer is further to determine an endpoint of the electronic speech signal based on the received information.

16. The apparatus of claim 14, wherein the speech analyzer is further to determine that the intermediate recognition result is the final recognition result based on the received information.

17. A method of decoding speech, comprising:
analyzing an electronic speech signal;
determining an intermediate recognition result of the electronic speech signal;
providing the intermediate recognition result for language interpretation;
determining if the intermediate recognition result is a final recognition result of the electronic speech signal; and
continuing analysis of the electronic speech signal until the intermediate recognition result is determined to be the final recognition result.

18. The method of claim 17, further comprising:
determining a new intermediate recognition result; and
providing the new intermediate recognition result for language interpretation.

19. The method of any of claims 17 to 18, further comprising:
receiving information related to language interpretation of the intermediate result; and
analyzing the electronic speech signal based on the received information.

20. The method of claim 19, further comprising:
determining an endpoint of the electronic speech signal based on the received information.

21. The method of claim 19, further comprising:
determining that the intermediate recognition result is the final recognition result based on the received information.
